(19) United States
(12) Patent Application Publication
(10) Pub. No.: US 2017/0004458 A1
(43) Pub. Date: Jan. 5, 2017

(54) METHOD AND SERVER FOR REPORTING AN ELECTRONIC CARD

(71) Applicant: ORANGE, Paris (FR)

(72) Inventors: Fano Ramparany, Grenoble (FR); Cédric Pronzato, Bernin (FR)

(21) Appl. No.: 15/039,799

(22) PCT Filed: Nov. 21, 2014
(86) PCT No.: PCT/FR2014/052991

§ 371 Date: May 26, 2016

(30) Foreign Application Priority Data
Nov. 29, 2013 (FR) 1361870

(51) Int. Cl. G06Q 10/10; G06Q 50/00

(52) U.S. Cl. CPC G06Q 10/1093; G06Q 50/01

(57) ABSTRACT

One embodiment provided herein relates to a method for notifying, by a server of a telecommunications network, an electronic card associated with an owner-user registered with this server. The method may comprise registering a recipient-user of the electronic card, obtaining information data relating to the owner-user and information data relating to the recipient-user, and searching for information data common to the owner-user and recipient-user among the information data obtained. If at least one common piece of information data is detected, the electronic card may be notified via the telecommunications network.

### BACKGROUND OF THE INVENTION

The invention relates to the general field of communications.

It more particularly concerns the field of physical cards (physical objects) or virtual cards embedded with information on their owners. This information may be identification data for example such as a name, address (personal or professional, postal or electronic), telephone number, photograph, etc.

Said cards may be calling cards or business cards routinely exchanged between the owner-users of these cards containing data relating to the owner and users known as holders or recipients of these cards who have been given the cards by the owner-users.

In the current state of the art, the information displayed on these cards whether physical or virtual is static i.e. immovable. This information is also passive in that the sole interaction possible with this information for a recipient-user of the card is the reading thereof.

These cards are therefore of relatively restricted use.

Interaction possibilities via these cards between owner-users and recipients are also currently limited to direct exchanges between these users (e.g. telephone or computational exchanges) on the initiative of the recipient-user on the basis of information displayed on the card.

### OBJECT AND SUMMARY OF THE INVENTION

The invention proposes extending the use of physical or virtual cards containing information relating to the card owners by adding thereto new means and new functionalities intended to facilitate interactions between owners and persons in possession of these cards. For this purpose it is based first on the card properly so-called which, according to the invention, is equipped with means allowing notification to be given to the recipient-user of this card of the existence of interaction opportunities with the owner of the card, and secondly on a server deployed in a telecommunications network communicating with the card and able to detect the existence of such opportunities.

In the meaning of the invention, by “owner-user” of the card is meant the user corresponding to the information displayed on the card, and by “recipient-user” is meant a user to whom the owner-user has given his/her card.

The invention thus concerns a method for notifying, by a server of a telecommunications network, an electronic card associated with an owner-user and registered with this server, this method comprising:
a registration step of registering a recipient-user of the electronic card;
an obtaining step of obtaining information data relating to the owner-user and information data relating to the recipient-user;
a search step of searching for information data common to the owner-user and recipient-user among the information data obtained; and
if at least one common piece of information data is detected, a notification step of notifying the electronic card via the telecommunications network.

Correlatively, the invention also concerns a server of a telecommunications network comprising:
a registration module capable of registering an electronic card associated with an owner-user and a recipient-user of this electronic card;
an obtaining module to obtain information data relating to the owner-user and information data relating to the recipient-user;
a search module to search for information data common to the owner-user and recipient-user among the information data obtained; and
a notification module to notify the electronic card via the telecommunications network, activated if at least one common piece of information data is detected by the search module.

The invention also concerns an electronic card associated with an owner-user and registered with a server, comprising:
a communication module to communicate with the server, arranged to receive a notification sent by the server when at least one piece of information data common to the owner-user and a recipient-user of the electronic card has been detected by the server; and
an alert module to alert the recipient-user of the electronic card, activated on receipt of the notification.

The information data relating to the owner-user and recipient-user may be of very varying type and may originate from sources external to the electronic card itself. For example they may concern:
data retrieved from a profile of the user;
user location data;
data representing a user activity; and/or
data derived from social network servers.

Evidently other types of data can be envisaged as a variant, in addition to or in replacement of the aforementioned data.

The search for data common to the owner-user and recipient-user of the card particularly allows the detection of the existence of one or more exchange opportunities between these users (ex. participation in a common event entered into the calendars of the users, events related to the activity of the owner-user of interest for the recipient-user of the card etc.). This search may entail identifying any common data among the information data collected by the server, or as variant common data meeting one of more predetermined criteria. Said criteria may in particular be selected by the owner-user of the card so as to filter possible exchanges notified to the recipient-user of the card (e.g. criterion regarding the professional or personal nature of the information data, criterion regarding a location associated with these data) or they may depend on the recipient-user of the card, etc.

Once detected by the server subsequent to the registration of the owner-user and the recipient-user, the exchange opportunities are notified to the card which in turn informs the recipient thereof via the recipient's alert module. In the example of a physical electronic card, this alert module may be in the form of a light-emitting diode (LED) or a buzzer or a sound alert module activated on receipt of the notification from the server.

With the invention therefore it is proposed that the card exchanged between the owner-user and recipient-user can be made proactive. This proactive card allows the very simple creation and maintaining of a social link between these two persons in a manner transparent to them once the exchange of the card has been registered with the server.

In addition, the invention offers the possibility of preserving the confidentiality of owner-user information data collected by the server with respect to the recipient-user of the card. Solely the server needs to access the details of these information data to conduct the search for data common to both users. On the other hand, the notification sent by the server to the card may advantageously not contain these data, nor contain details on the exchange opportunity underlying the detection by the server of data common to the users.

It is to be noted that advantageously the card of the invention does not need to be equipped with complex, costly means. It is sufficient to provide the card with alert means intended to notify the recipient-user and with a server communication module to receive information on the existence of data common to the owner-user identified on the card and to the recipient of this card.

If the card is a physical card this communication module may comprise a direct connection module with the telecommunications network of the server, or as a variant it may comprise a connection module to an intermediate equipment connected to the telecommunications network of the server via which the notification sent by the server is received. The connection module may integrate an RFID module for example (Radio Frequency IDentification), or USB port, etc. In particular, the intermediate equipment may be a reader or a terminal dedicated to coupling with the card, or as a variant it may be a computer provided with a communication port compatible with the connection module of the card.

It is thus possible to maintain a very compact format for the card compatible with existing business or calling cards. Said physical electronic card has the advantage of being tangible for the users. The recipient-user of the card is then able to connect to a website or a portal served by the server to obtain more information on the exchange opportunity or more generally on the common data that has been detected by the server. Access to such data can be configured by the owner-user to filter the information given to the recipient-user.

The invention therefore has preferred application, but not limited thereto, to the field of the Internet of Things intended to associate intelligent interfaces with physical objects for connection and communication within varied contexts of use, via telecommunications networks such as the Internet.

It is to be noted however that the invention can also be applied to an electronic card of virtual type (i.e. an application) having software communication means with the server and provided with recipient-user alert means (e.g. display of a suitable symbol, emission of a predetermined sound, etc.).

In one particular embodiment of the invention the method of the invention further comprises a step to aggregate information data obtained relating to the owner-user and information data obtained relating to the recipient-user, within a data structure designed for providing a single representation of information data common to the owner-user and to the recipient-user whilst associating such information data with each user.

Said data structure can be modelled with a graph for example.

Graphs are powerful tools allowing easy, synthesised representation of information data and in particular of the concepts contained in these data and the relations linking these concepts together. All the concepts and the relations linking these concepts together is also known as an ontology. For example information data according to which “X is registered for a conference CONF Y” can be modelled by a graph comprising two nodes associated with concept “X” and with concept “conference CONF Y” respectively, and an arc linking these two nodes having the meaning “is registered for”.

The aggregation step can therefore advantageously comprise an analysis of the information data obtained from a previously defined ontology comprising a plurality of types of concepts representing information data and of relations linking these concepts.

This aggregation step allows merging of information data whilst preserving the unicity of the underlying concepts contained in these data. In this manner, in the structure of aggregated information data, the duplication of representations of information data common to the users is avoided. The resulting structure of aggregated data is therefore advantageously in a synthetic form.

Therefore in the example of a data structure modelled by a graph, the aggregation step may for example consist in constructing a graph having nodes (or vertices) and the arcs are deduced from information data on the owner and on the recipient of the card, each node being associated with a separate concept. By way of illustration, if it arises from the data obtained by the server that X the owner of the card is registered for a conference CONF Y, and that Z the recipient of the card is also registered for the same conference CONF Y, the graph constructed at the aggregation step will contain a single node associated with conference CONF Y linked via two separate arcs to the nodes associated with the users “X” et “Z”.

By means of the aggregation step the search for common elements among the information data obtained on the owner and on the recipient of the card is largely facilitated. Similarly, the search for specific common elements characterizing a particular type of interaction or a particular concept can easily be conducted via a search for a fragment of the data structure corresponding to this type of interaction.

Additionally, with this embodiment it is possible to use existing languages (or models) for resource description and query. In particular, use of the description language RDF (Resource Description Framework) routinely used to describe Web resources and their metadata, or of a derivative description language of RDF, and of the SPARQL query language (SPARQL Protocol and RDF Query Language) allowing querying of RDF models can be envisaged to implement the obtaining step, and where applicable, the aggregation and search steps of the invention.

Evidently the invention is not limited to the use of the aforementioned languages, and other languages such as the SQL language (Structured Query Language) or proprietary description and query languages can be used.

In one particular embodiment of the invention, after obtaining new information data relating to the owner-user and/or recipient-user, the steps of searching and where applicable notification are repeated taking into account the new information data obtained.

The obtaining of new information data can be carried out on the initiative of the server, or as a variant in push mode if the new information data concerning the owner or recipient of the card is detected by sources hosting such data which inform the server thereof (for example further to subscription of the server to these information sources).

The invention can therefore provide the recipient of the card with relevant information relating to the owner, updated in real time.

In one particular embodiment, the different steps of the notification method are determined by computer program instructions.

Therefore, the invention also concerns a computer program on a data medium, this program suitable for being performed in a server or more generally in a computer, this program comprising instructions adapted to performing steps of a notification method such as described above.

This program can use any programming language and can be in the form of source code, object code form or code intermediate between source code and object code, e.g. in a partially compiled form or in any other desirable form.

The invention also concerns a computer-readable data medium comprising instructions for a computer program such as indicated above.

The data medium can be any entity or device capable of storing the program. For example the medium may comprise storage means such as a read only memory (ROM), e.g. a Compact Disk (CD) ROM or ROM of a microelectronic circuit, or magnetic recording means e.g. a floppy disc, or a hard disc.

Also, the data medium may be a transmissible medium such as an electric or optical signal which can be conveyed via an electrical or optical cable, via wireless or other means. In particular, the program of the invention can be downloaded onto a network of Internet type.

Alternatively, the data medium may be an integrated circuit in which the program is incorporated, the circuit being adapted to execute or to be used to execute the method under consideration.

The invention also concerns a system comprising a server and an electronic card conforming to the invention.

This electronic card can be physical or virtual.

It is also possible, in other embodiments, to envisage that the notification method, the server, the electronic card and the system of the invention have all or part of the aforementioned characteristics in combination.

### BRIEF DESCRIPTION OF THE DRAWINGS

Other characteristics and advantages of the present invention will become apparent from the description below given with reference to the appended drawings illustrating examples of embodiments that are not in any way limiting. In the Figures:

FIG. 1 schematically illustrates a system, a server and an electronic card conforming to the invention in one particular embodiment;

FIG. 2 schematically illustrates the architecture of the electronic card in FIG. 1;

FIG. 3 schematically illustrates the physical architecture of the server in FIG. 1;

FIG. 4 is a flowchart illustrating the main steps of a notification method according to the invention such as implemented by the server in FIG. 1, in one particular embodiment;

FIGS. 5A-5E illustrate examples of graphs and of a query in a graph able to be used by the server in FIG. 1.

### DETAILED DESCRIPTION OF THE INVENTION

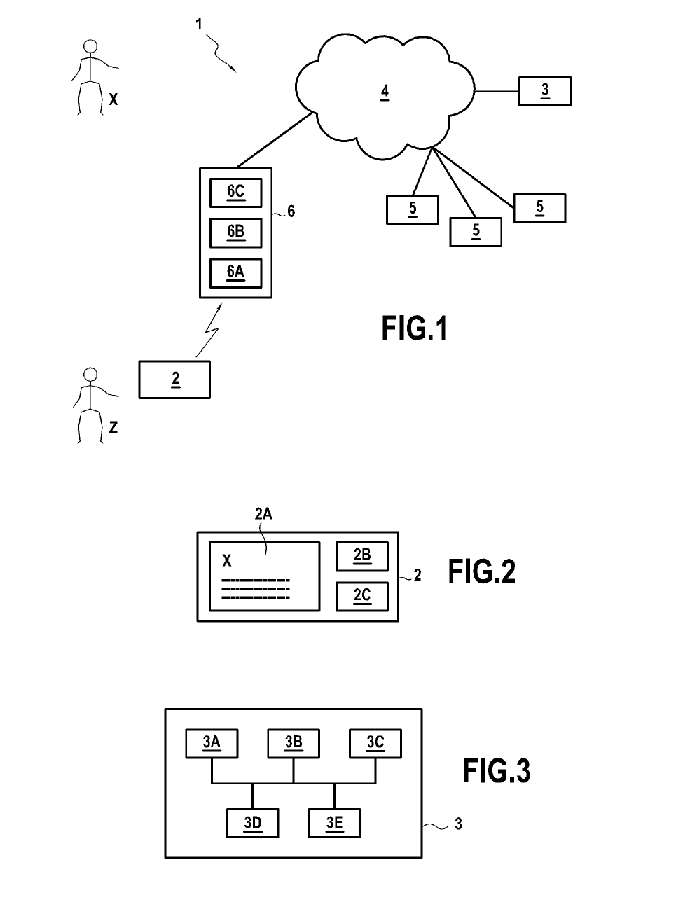

FIG. 1 illustrates a system 1 in its environment conforming to the invention in one particular embodiment.

In the example envisaged in FIG. 1, the system 1 allows the creation and maintaining of a social link between two users X and Z via the exchange of a proactive, electronic calling card 2 conforming to the invention on which identification data relating to user X are displayed (e.g. user name, personal or professional address, etc.). The electronic card 2 here is a physical card. The user X is an owner-user of the electronic card 2 in the meaning of the invention, who has given his/her electronic calling card 2 to user Z. User Z is therefore a recipient-user of the electronic card 2 in the meaning of the invention.

To create and maintain this social link, the system 1 is based on the electronic card 2 given by user X to user Z, and on a server 3 conforming to the invention connected to a telecommunications network 4. The telecommunications network 4 here is a public Internet network for example. However there are no limitations to the type of network 4; it may just as well be a fixed or mobile network, public or private, wire or wireless, etc.

The server 3, according to the invention, is adapted to aggregate and correlate information data relating to user X and user Z made available thereto via different information sources 5 to identify common data likely to create exchange opportunities between both users and to notify the electronic card 2 held by user Z of the existence of such opportunities where applicable (i.e. if such exist). It is assumed for this purpose that user X has subscribed to the service offered by the server 3 and at the time of subscription has registered therewith the electronic card 2 and possibly other electronic cards in its name identical to electronic card 2 and intended for future contacts. Each electronic card is identified at this time of this registration by an identifier or ID code: therefore the electronic card 2 is associated with user X with the server 3 and identified by an identifier ID2.

There is no limitation attached to the information sources 5 providing the server 3 with information data. These information sources can be maintained by the server 3 or as a variant by third parties and communicate to the server 3 via the telecommunications network such as telecommunications network 4. In addition, the information data supplied by the sources 5 can be of different types. In particular it may the following, this list not being exhaustive:
information data retrieved from user profiles (e.g. age, profession, professional and/or personal interests, employer, skills, etc.), held by the server 3 for example or by fixed or mobile network operators to which users X and Z have subscribed and with which the server 3 is in partnership;
location information data on users X and Z provided to the server 3 for example, where applicable by the operators of the mobile networks of users X and Z;
information data representing an activity of users X and Z pushed to the server 3 by an electronic calendar application used by users X and Z (e.g. in association with their electronic messaging service);
data originating from servers managing social networks;
etc.

The choice of information sources 5 can be decided by the server 3 (in other words by the operator of the service offered by the server 3), or as a variant it can be configured by user X as a function of X's preferences. It can also be configured by user X so as to be dependent on user Z (in particular in relation to information that user X wishes to make accessible to user Z or in relation to opportunities X wishes to have with user Z).

In the embodiment described here the server 3 communicates with the electronic card 2 via an intermediate equipment 6. In the example envisaged in FIG. 1, the intermediate equipment 6 is a personal computer belonging to user Z and equipped with a connection module 6A to the electronic card 2, with communication means 6B on the network 4 and with a display screen 6C. The connection module 6A is a USB (Universal Serial Bus) port or connector for example, or a short-distance wireless communication module using RFID technology for example (Radio Frequency Identification) or Bluetooth, etc. The intermediate equipment 6 acts as relay for the notifications sent by the server 3 to the electronic card 2.

As a variant, the intermediate equipment 6 may be a dedicated card reader comprising connection means 6A with the electronic card 2 and communication means 6B on the network 4.

The electronic card 2 is equipped with a connection module compatible with the connection module 6A of the intermediate equipment 6. FIG. 2 schematically illustrates the architecture of the physical electronic card 2 given by user X to user Z. In the example illustrated in FIG. 2 the electronic card 2 has the format of a calling card and comprises:
a display area 2A of identification data of user X;
an alert module 2B, located on the outer surface of the electronic card 2, and for example comprising a buzzer or light-emitting diode to inform user Z of the receipt of a notification from the server 3; and
a communication module 2C here including the connection module compatible with the connection module 6A of the intermediate equipment 6 (USB port or connector, RFID or Bluetooth module, etc. in relation to the type of connection module 6A).

In one variant of embodiment, the electronic card 2 is capable of communicating directly with the server 3 via the telecommunications network 4 without requiring any intermediate equipment such as equipment 6. The communication module 2C then integrates a connection module to the telecommunications network 4 or to a network connected to the telecommunications network 4.

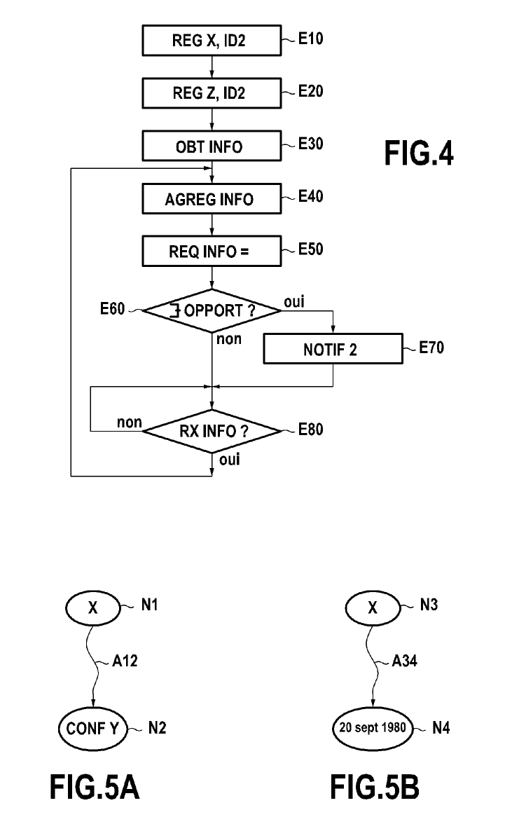

Evidently, the electronic card 2 may take on other forms than the one schematically illustrated in FIG. 2. It may also integrate other additional means such as a microprocessor for example or programmable logic circuit, one or more memories enabling it to store the information transmitted in particular by the server 3, a display screen for information display, etc. In the embodiment described here, the server 3 has the physical architecture of a computer such as schematically illustrated in FIG. 3. In particular, it comprises a processor 3A, a read only memory 3B, a random access memory 3C, a non-volatile memory 3D and communication means 3E on the telecommunications network 4. The read only memory 3B of the server 3 forms a recording medium readable by the processor 3A and on which a computer program conforming to the invention is stored comprising instructions for the execution of the steps of a notification method conforming to the invention, the steps of this notification method being described later with reference to FIG. 4 in one particular embodiment.

This computer program in equivalent manner defines functional (software) modules of the server 3 e.g. in particular a registration module for registering the electronic card 2 and of the recipient-user Z of the electronic card 2, an obtaining module to obtain information data relating to user X and to user Z from information sources 5 and an aggregating module for aggregating these data, a search module to search data common to users X and Z among aggregated data and a notification module to notify the electronic card 2 when applicable. The obtaining and notification modules use the communication means 3E in particular on the telecommunications network 4 of the server 3. The functions of these various modules are described in more detail with reference to the steps of the notification method illustrated in FIG. 4.

With reference to FIG. 4 a description is now given of the main steps of the notification method according to the invention such as implemented by the server 3 in FIG. 1 in one particular embodiment.

As mentioned above, it is previously assumed that user X has subscribed to the service offered by the server 3. At the time of this subscription, user X registered the electronic card 2 with the server 3 (i.e. with the registration module of the server 3) giving its identifier ID2 (step E10), and possibly other electronic cards identical to electronic card 2 intended for other users.

It is also assumed that user X gives his/her electronic card 2 to user Z and that user Z registers with the registration module of the server 3 (step E20). At the time of this registration user Z provides the identifier ID2 of the electronic card 2 and an own identifier (e.g. name and/or telephone number, etc.).

Further to this registration, the server 3, via the telecommunications network 4, sends a query to the information sources 5 identifying users X and Z to obtain information data relating to these users available at the sources 5. This query may be in the form of a subscription with all or part of the sources 5 so that they transmit to the server 3 on their own initiative (i.e. in push mode) the information data relating to users X and Z in their possession as soon as they obtain these data or as soon as they are updated.

As a variant, the query sent by the server 3 can be repeated periodically or in predetermined manner so as to receive relevant updated information data originating from sources 5 relating to users X and Z.

The server 3, via its software obtaining module, therefore obtains from the information sources 5 the information data held by these sources on users X and Z (step E30).

In the embodiment described here the server 3 aggregates the information data received from the different information sources 5 in the form of a graph G conforming to the description language RDF. This language is described in particular in the document: RDF—Semantic Web Standards available on the website www.w3.org/RDF.

As it is known, the RDF language describes any piece (item) of information in the form of a model and more specifically a graph representing the concepts involved in this piece of information and the relations linking these concepts together. By way of illustration, if the piece of information under consideration is “X is registered for a conference CONF Y”, the concepts involved in this piece of information are “X” and “conference CONF Y”, and the relation linking these concepts is “is registered for”.

More specifically, to guarantee coherency and good interpretation of the models, the RDF language is based on the definition and use of ontologies which are themselves RDF models defining types of data or objects to which the concepts contained in each piece of information pertain. An ontology in a data processing context, designates the conceptualisation of a field of knowledge. By conceptualisation it is meant herein the definition of the terms that are necessary to express the meaning of an piece of information relating to this field and the properties of these terms. The terms include object types (or classes) and relations between these object types. One property of a relation is its transitivity for example.

In other words, an ontology designates both a choice regarding the manner to describe a field, and the formal description of this field. Ontologies are routinely used in fields such as artificial intelligence, semantic web, software engineering, etc.

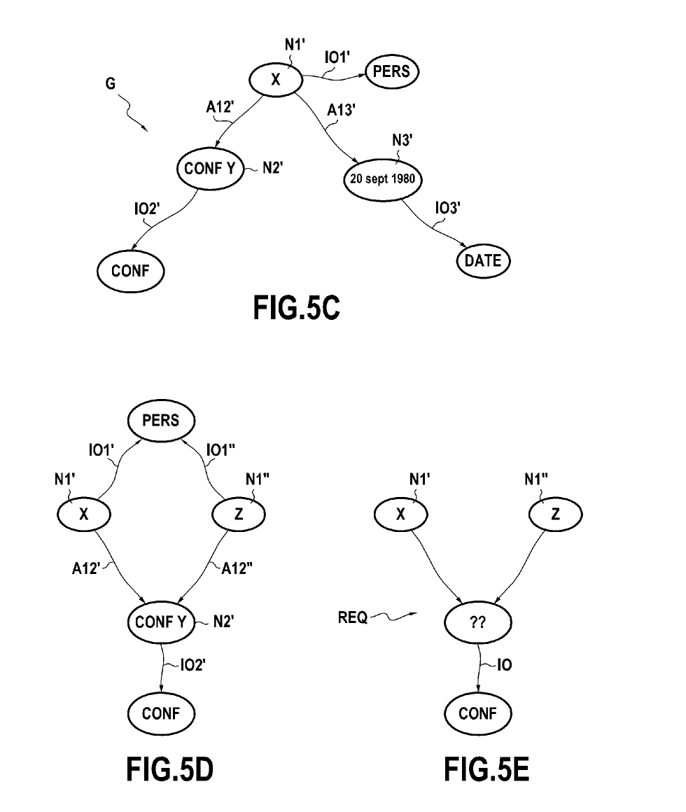

FIGS. 5A and 5B illustrate two examples of graphs conforming to RDF language respectively modelling an piece of information (or in equivalent manner a set of information data in the meaning of the invention) stipulating that “X is registered for a conference CONF Y” and an piece of information stipulating “X was born on 20 September 1980”.

More specifically, with reference to FIG. 5A, the piece of information “X is registered for a conference CONF Y” is modelled conforming to RDF language by a graph comprising two separate nodes N1 and N2 respectively associated with concept “X” and with concept “CONF Y”. The concepts “X” and “conference CONF Y” are associated with different data types or object types namely a “PERSON” type (“X”) and a CONFERENCE type (“conference CONF Y”). The concepts carried by nodes N1 and N2 are linked by a relation A12 of type “is registered for”.

Similarly, with reference to FIG. 5B, the piece of information “the date of birth of X is 20 September 1980” is modelled conforming to RDF language by a graph comprising two separate nodes N3 and N4 respectively associated with concept “X” and with concept “20 September 1980”. The concepts “X” and “20 September 1980” are associated with different data types namely a PERSON type (“X”) and a DATE type (“20 September 1980”). The concepts carried by the nodes N3 and N4 are linked by a relation A34 of type “date of birth is”.

Aggregation by the server 3 of the information data obtained from sources 5 is therefore based on the prior definition of an ontology allowing the representation of these information data in the form of a single graph G in which a piece of information (typically a concept) common to the information sources 5 and to the users under consideration is represented by a single element in the graph namely by a single node in this graph; in this manner duplication is avoided of the underlying concepts represented in this graph.

This definition of ontology comprises the typing of concepts contained in the information data i.e. the definition of the types or classes of objects to which the different information data relate, and of the relations linking these types or classes of objects. This typing of concepts can be predefined and previously determined as a function of the type of information the server 3 expects to receive from the information sources 5 or the type of information sources 5 addressed by the server 3. For example it may comprise the following types of concepts: PERSON, DATE, PLACE, CONFERENCE, HOBBY, FRIENDS, etc., and the following relations “is registered for”, “date of birth is”, “is at”, “hobby is”, “friend is”, etc.

As a variant, the typing of concepts can be determined dynamically by the server 3 from analysis (semantic in particular) of the information data it receives from the sources 5.

In another variant, this typing can originate from the information sources 5 themselves if they already use a graphical representation conforming for example to RDF language to model the information data in its possession on users X and Z.

In a further variant, a combination of the aforementioned variants can be envisaged.

At the time of information data aggregation, the server 3 analyses the information data obtained from the sources 5 using the previously defined ontology. More specifically, it identifies each concept contained in the information data and associates with each identified concept a type of concept in the previously defined ontology. For example, in the piece of information “X is registered for conference CONF Y” it identifies the concept “X” and the concept “conference CONF Y”, and associates with concept “X” the type “PERSON” and with concept “conference CONF Y” the type “CONFERENCE”.

It also determines the relations linking together the concepts thus identified.

The server 3 then constructs a single graph G from the identified concepts and relations wherein:
each separate concept is associated with a single node;
each node in the graph is linked to one or more other nodes in the graph as a function of the relations linking the concepts together in the information data received from the sources 5.

FIG. 5C illustrates aggregation, conforming to the invention, of the information data “X is registered for a conference CONF Y” and “date of birth of X is 20 September 1980”.

In these information data the server 3 identified the concepts “X” of “PERSON” type (abbreviated to “PERS” in the Figure), “conference CONF Y” of “CONFERENCE” type (abbreviated to “CONF” in the Figure) and “20 September 1980” of “DATE” type. Each different concept is associated with a single node in the graph G, namely:
“X” is associated with node N1′ which is an instance of “PERSON” type (modelled by link IO1′ in the graph);
“conference CONF Y” (abbreviated to “CONF Y” in the Figure) is associated with the node N2′ which is an instance of “CONFERENCE” type (modelled by link 102′ in the graph); and
“20 September 1980” (abbreviated to “20 Sept 1980” in the Figure) is associated with the node N3′ which is an instance of “DATE” type (modelled by link 103′ in the graph).

The node N1′ is linked to the two concepts <<conference CONF Y>> and <<20 September 1980>> via two different links A12′ and A13′ respectively modelling the relations <<is registered for>> and <<date of birth is>>.

According to another example FIG. 5D illustrates aggregation, conforming to the invention, of the information data “X is registered for a conference CONF Y” and “Z is registered for a conference CONF Y”.

Within these information data the server 3 identifies the concepts “X” and “Z” of “PERSON” type (abbreviated to “PERS” in the Figure) and “conference CONF Y” of “CONFERENCE” type (abbreviated to “CONF” in the Figure). Each different concept is associated with a single node in the graph G, namely:
“X” is associated with the node N1′ which is an instance of “PERSON” type (modelled by link IO1′ in the graph);
“conference CONF Y” (abbreviated to “CONF Y” in the Figure) is associated with the node N2′ which is an instance of “CONFERENCE” type (modelled by link 102′ in the graph); and
“Z” is associated with the node N1″ which is an instance of “PERSON” type (modelled by link IO1″ in the graph).

The concept “conference CONF Y” is common to both users X and Z. The node N2′ is therefore linked to the two concepts “X” and “Z” via two separate links A12′ et A12″ respectively modelling the relation “is registered for”. Therefore according to this example the duplication of common concepts is avoided. It is to be noted on the other hand that this does not apply here to the relations linking the concepts together (e.g. two separate links A12′ and A12″ link the nodes N1′ and N1″ to node N2′). The graph G constructed by the server 3 is a data structure advantageously designed for providing a single representation of the different concepts contained in the information data received from the sources 5. This graph is designed to prevent the representation several times in the graph G (in other words by means of separate representation elements) of information data (and in particular concepts) common to the users. These common information data on the contrary are represented by a single node linked to the users sharing these data. The graph G therefore offers a synthesised representation of the information data obtained from the sources 5, and in this form allows easy, rapid identification of data common to users X and Z.

It is to be noted however that the invention is not limited to the use of graphs and other structures of aggregated data can be envisaged to represent information data obtained from the information sources 5, such as tuples (i.e. n-uplets) of relational models conventionally used in databases. These alternative data structures are preferably designed to prevent the duplication of elements representing information data common to the two users and to sources. However, it can also be envisaged to use a sub-optimal structure of aggregated data in which such duplications exist.

After the aggregation step, the server 3 searches in the graph G for information data common to user X and user Z (step E50). This search step enables the server 3 to identify interaction opportunities (i.e. exchanges) between user X the owner of the electronic card 2 and user Z the recipient thereof.

As previously mentioned, the definition of ontologies and the construction of the graph G advantageously facilitate this search. An interaction opportunity between users X and Z is detected by searching graph fragments characteristic of this interaction, in other words characteristics of searched common data. For example, to detect a common registration of users X and Z for one same conference, the server 3 searches in graph G for the presence of the sub-graph illustrated in FIG. 5E, in which the concept or node “??” is a variable of “CONFERENCE” type.

Such a search is conducted by the server 3 by applying a specific query to graph G and defining the desired graph fragment (i.e. characteristic of common data). This query is expressed in the embodiment described here by means of the dedicated SPARQL language known per se. The concept represented by the variable “??” can identify with any concept of the graph provided that the relations linking it to neighbouring nodes are identical to those of the fragment defined in the query. In the example illustrated FIG. 5D, this concept must be linked to users X and Y via links of the type “is registered for”, and must be a concept of “CONFERENCE” type (modelled by link IO in the graph fragment in FIG. 5D).

Evidently this example is only given by way of illustration and other occurrences can be searched in the graph G to identify information data common to user X and user Z.

It is to be noted that the server 3 can define queries so as to search for any type of data common to users X and Z, or on the contrary for common data meeting one or more predetermined criteria decided by user X for example (e.g. search for attendance at one and the same conference whilst not searching for data relating to hobbies common to both users for example). It can therefore be envisaged that user X, when subscribing or at a later time, is able to define or limit the type of interactions it wishes to have searched by the server.

Also several queries concerning different types of concepts for example can be applied by the server 3 to the graph G.

If the application of such a query by the server 3 returns a positive result (yes reply at test step E60), in other words if the graph fragment defined in the query is present in the graph G, this means that there is in graph G at least one piece of data common to users X and Z conforming to this graph fragment. The reply to the query gives the concept that is common to users X and Z i.e. in the example in FIG. 5D the common concept of “CONFERENCE” type with which the variable “??” of the query has been identified, also in other words the common conference for which users X and Z are registered.

The server 3 here associates with the common (piece of) data thus detected an interaction opportunity between users X and Z. It notifies the electronic card 2 of the existence of this opportunity or more generally of the existence of data common to users X and Z (step E70).

This notification is sent to the electronic card 2 via its communication means 3E over the telecommunications network 4. In the embodiment described here, it is transmitted to the electronic card 2 via the intermediate equipment 6.

On receipt of this notification, the electronic card 2 alerts user Z by activating its alert module 2B. In other words, the electronic card 2 lights up if the alert module comprises a diode of LED type or vibrates if it comprises a buzzer on receipt of the notification from the server 3.

User Z thus notified can then connect to a portal managed by the server 3 for example, via the intermediate equipment 6 to take note of the notification sent by the server 3 and in particular to access more information on the exchange opportunity with user X detected by the server 3 (e.g. type of opportunity, namely here attendance at a common conference, name of the conference etc.). This information can be visualised by user Z on the display screen 6C of the intermediate equipment 6.

As a variant user Z can access this information by means of a device separate from the intermediate equipment 6.

In the embodiment described here the search for information data common to users X and Z is repeated whenever one or more information sources 5 provide the server 3 with new information data on user X and/or on user Z (step E80, and yes reply at step E80 looping back onto step E40) retrieved from the graph G in which these new information data are integrated.

It is noted that when an exchange opportunity is detected by the server 3 at a time when the electronic card 2 is not connected to intermediate equipment 6 and is thus unable to receive notification from the server 3, the server 3 is able to store in memory this opportunity and information related thereto originating from graph G and to notify the existence of this opportunity as soon as it detects the connection of the electronic card 2 to the intermediate equipment 6 or as soon as the electronic card 2 is again registered with the server 3.

In the embodiment described here the electronic card 2 is a physical card in other words a physical object. As a variant the electronic card 2 may be a virtual card (i.e. an application) provided with software communication means with the server and recipient-user alert means (e.g. display of a suitable symbol, emission of a predetermined sound, etc.).

1. A method for notifying, via a server of a telecommunications network, an electronic card associated with an owner-user and registered with this server, said method comprising:
registering a recipient-user of the electronic card;
obtaining information data relating to the owner-user and information data relating to the recipient-user;
searching for information data common to the owner-user and recipient-user among the information data obtained; and
if at least one common piece of information data is detected, notifying the electronic card via the telecommunications network.

2. The method according to claim 1 further comprising aggregating the information data obtained on the owner-user and the information data obtained on the recipient-user within a data structure designed for providing a single representation of information data common to the owner-user and to the recipient-user whilst associating such information data with each user.

3. The method according to claim 2 wherein the data structure is modelled by a graph.

4. The method according to claim 2 wherein the aggregation process comprises an analysis of the information data obtained from a previously defined ontology comprising a plurality of types of concepts representing information data and of relations linking these concepts.

5. The method according to claim 3 wherein the graph conforms to the description language RDF (Resource Description Framework) or to a derivative RDF language.

6. The method according to claim 1 wherein, after obtaining new information data relating to the owner-user and/or recipient-user, the search process and where applicable the notification process are repeated taking into account the new information data obtained.

7. The method according to claim 1 wherein the information data relating to the owner-user and/or recipient-user are at least selected from the group consisting of:
data retrieved from a profile of the user;
user location data;
data representing a user activity; and
data derived from social network servers.

8. A computer having stored thereon a program comprising instructions to implement the notification method according to claim 1 when said program is executed by said computer.

9. A non-transitory computer-readable medium having stored thereon instructions which cause a computer to perform the notification method according to claim 1 when said instructions are executed by said computer.

10. A server of a telecommunications network, said server being configured to:
register an electronic card associated with an owner-user and recipient-user of the electronic card;
obtain information data relating to the owner-user and information data relating to the recipient-user;
search for information data common to the owner-user and recipient-user among the information data obtained; and
notify the electronic card via the telecommunications network, activated if at least one common piece of information data is detected by the search module.

11. An electronic card associated with an owner-user and registered with a server, said electronic card being configured to:
communicate with the server, and to receive a notification sent by the server when at least one piece of information data common to the owner-user and a recipient-user of the electronic card has been detected by the server; and
on receipt of said notification, to alert the recipient-user of the electronic card.

12. The electronic card according to claim 11 wherein the electronic card is configured to connect to said telecommunications network of said server.

13. The electronic card according to claim 11 wherein the electronic card is configured to connect to intermediate equipment connected to the telecommunications network of the server via which said notification from the server is received.

14. A system comprising:
a server according to claim 10; and
an electronic card associated with an owner-user and registered with a server, said electronic card being configured to:
communicate with the server, and to receive a notification sent by the server when at least one piece of information data common to the owner-user and a recipient-user of the electronic card has been detected by the server; and
on receipt of said notification, to alert the recipient-user of the electronic card.

15. The system according to claim 14 wherein the electronic card is a physical electronic card.
